(19) United States
(12) Patent Application Publication
(10) Pub. No.: US 2026/0204832 A1
(43) Pub. Date: Jul. 16, 2026

(54) CONNECTOR MODULE COMPRISING A LEAD FRAME, ACTUATOR, AND METHOD FOR ASSEMBLING THE CONNECTOR MODULE

(71) Applicant: Schaeffler Technologies AG & Co. KG, Herzogenaurach (DE)

(72) Inventors: Marc BEYER, Haguenau (FR); Jean-Georges Friedmann, Hatten (FR); Pascal Verbucheln, Buhl (DE)

(73) Assignee: Schaeffler Technologies AG & Co. KG, Herzogenaurach (DE)

(21) Appl. No.: 19/137,724

(22) PCT Filed: Nov. 28, 2023
(86) PCT No.: PCT/DE2023/100927

§ 371 Date: Jun. 11, 2025

(30) Foreign Application Priority Data
Dec. 15, 2022 (DE) 10 2022 133 374.4

(51) Int. Cl. H01R 13/506; H01R 13/426; H01R 13/66; H01R 43/18; H01R 43/20

(52) U.S. Cl. CPC H01R 13/506; H01R 13/426; H01R 13/6658; H01R 43/18; H01R 43/205; H01R 2201/10

(57) ABSTRACT

The invention relates to a connector module (1) comprising a housing (2), a lead frame (3), contacts (4) for bringing the lead frame (3) into contact with a load, and supports (5) for supporting the contacts (4).

A support ring (6) is accommodated in the housing (2). The support ring (6) integrally forms both the supports (5) and further fastening elements (7) for fastening the lead frame (3) to the housing (2).

### CROSS-REFERENCE TO RELATED APPLICATIONS

This application is the U.S. National Phase of PCT Appln. No. PCT/DE2023/100927, filed Nov. 28, 2023, which claims the benefit of German Patent Appln. No. 102022133374.4, filed Dec. 15, 2022, the entire disclosures of which are incorporated by reference herein.

### TECHNICAL FIELD

The present disclosure relates to a connector module comprising a housing, a lead frame, contacts for contacting the lead frame with a load and supports for supporting the contacts. The application further comprises an actuator comprising such a connector module and a method for assembling such a connector module.

### BACKGROUND

DE102019102713 A1 discloses a connector module with a lead frame. The lead frame is overmolded here and guided around an electrolytic capacitor. The lead frame is then further connected to a circuit board through which it is guided and connected to the terminals for controlling or supplying power to an actuator. It is necessary that the lead frame is guided and supported. The same applies to the circuit board. In addition, appropriately stable contacts with the actuator motor terminals must be ensured. To ensure these requirements, a number of elements and work steps are necessary, which make assembly of the connector module complex and complicated.

### SUMMARY

The object of the present disclosure is therefore to at least reduce these problems from the prior art.

This object is achieved by a connector module according to the present disclosure.

Advantageous embodiments are provided in the present disclosure.

The connector module is characterized by the fact that a support ring is accommodated in the housing. The support ring itself can consist in particular of plastic or another inherently non-conductive, i.e. electrically insulating material. Furthermore, the support ring is not overmolded. The support ring integrally forms both the supports for supporting the contacts as well as further fastening elements for fastening the lead frame to the housing. Preferably, neither the lead frame nor the support ring is overmolded, i.e. they are designed without overmolding. Using the support ring, several functions can be covered simultaneously. It stabilizes the lead frame, supports the contacts for connecting to the lead frame and connects said lead frame to the housing. This in particular ensures easy assembly.

In order to enable simple serial assembly, preferably within the housing, according to a further development the supports for supporting the contacts and the fastening elements for fastening the lead frame are arranged on opposite sides of the support ring.

Particularly advantageously, the fastening elements can be female connectors or spacer sleeves for accommodating male connectors or pins on the housing side as housing structures. A corresponding reversal of the effect is also possible according to the disclosure, i.e. the fastening elements are male connectors or pins, and female connectors, sleeves or spacer sleeves are provided on the housing side. In this way, the support ring can be easily inserted into the housing and firmly connected to it. In particular, a radial alignment takes place, i.e. an alignment within the plane of the support ring. An axial alignment of the support ring with respect to the housing, i.e. in a direction perpendicular to the plane of the support ring, can also be made possible if corresponding borders, shoulders or stop contours are provided on the sides of the fastening elements or the complementary housing structures.

Simple manufacture and secure positioning of the support ring can be achieved if the pins are integrally formed from the housing and the spacer sleeves are integrally formed from the support ring.

An axial alignment of the lead frame, i.e. in a direction perpendicular to the plane of the support ring, can be made possible if corresponding borders, shoulders or stop contours are provided on the sides of the fastening elements. In particular, this can also be made possible only for a part of the fastening elements which, in addition to fastening the support ring to the housing, are also provided for fastening the lead frame to the support grid. Additional second fastening elements may also be provided solely for fastening the lead frame to the support ring. For this purpose, a male connector can protrude from a projection, while the projection has a surface parallel to the lead frame. A female connector or a spacer sleeve accordingly has a surface parallel to the lead frame, whereby the lead frame, when in contact with or on the support ring, is fixed in its axial position with respect to an axis through the housing by the lead frame being in contact with the two surfaces.

Furthermore, it is also possible to improve how the contacts are accommodated. For this purpose, it is possible for the contacts to be accommodated in contact receptacles of the housing, the contact receptacles comprising an axial surface or end face or end side. The support ring then has receptacles for receiving the contacts, which face the surfaces or end sides, i.e. point from the support ring towards the housing out of the plane of the support ring. The receptacles themselves also have a surface or end side with which they advantageously come into contact with the surface of the contact receptacle and thus enable the axial positioning and, in a further development, also a radial positioning of the support ring in relation to the contacts. It is possible to arrange the contact receptacles within the housing, which form a poka-yoke structure with the corresponding receptacles on the support ring sides. Furthermore, the receptacles are hollow so that the contacts protrude through the respective surfaces as well as through the receptacle. Furthermore, the lead frame is arranged on fastening elements and/or housing structures in such a way that the contacts protrude through it, in a manner contacting it, and are supported in the supports on the side of the support ring facing away from the lead frame. The supports are also designed to be hollow for this purpose. The supports can be geometrically designed in such a way that they either have a contact geometry with a conductive connection to the contacts or enable direct contact between the contacts on the lead frame or housing side and the conducting structures on the other hand.

For the actuator according to the disclosure, the load which contacts the lead frame is an electric motor. Control or measurement signals or an operating current or a combination of these can then be routed via the lead frame.

The object of the disclosure is also achieved by a method for assembling a connector module as described above.

This method requires the following steps to be performed to assemble the connector module:

Firstly, the contacts are accommodated in the contact receptacles of the housing.

In a second step, the lead frame is positioned by the contacts and pins of the housing in a radial direction with respect to an axis. At the same time as the radial positioning, axial positioning can also be carried out using projections, stops or similar.

The support ring is then arranged axially on the lead frame by accommodating the contacts in supports of the support ring.

The lead frame can also be axially fixed, additionally or alternatively in this method step, in that the lead frame is fixed in the axial direction by the surface or end side of the contact receptacles and the corresponding surface/end side of the spacer sleeves of the support ring as well as by the surface of projections of the pins.

In a final step, or through the sum of the previous steps, the support ring is fastened to the housing such that the lead frame is positioned and fastened solely via the support ring and the contacts. The contacts are accessible via the receptacles in the support ring for corresponding supply lines of a load, such as an electric motor. The contact can be made using an appropriate plug contact.

### BRIEF DESCRIPTION OF THE DRAWINGS

An example of the disclosure, to which the disclosure is not limited, and from which further features according to the disclosure may arise, is shown in the following figures. In the drawings:

FIG. 1: shows a section through a connector module;

FIG. 2: shows a three-dimensional view of the connector module;

FIG. 3: shows an exploded view of the connector module.

### DETAILED DESCRIPTION

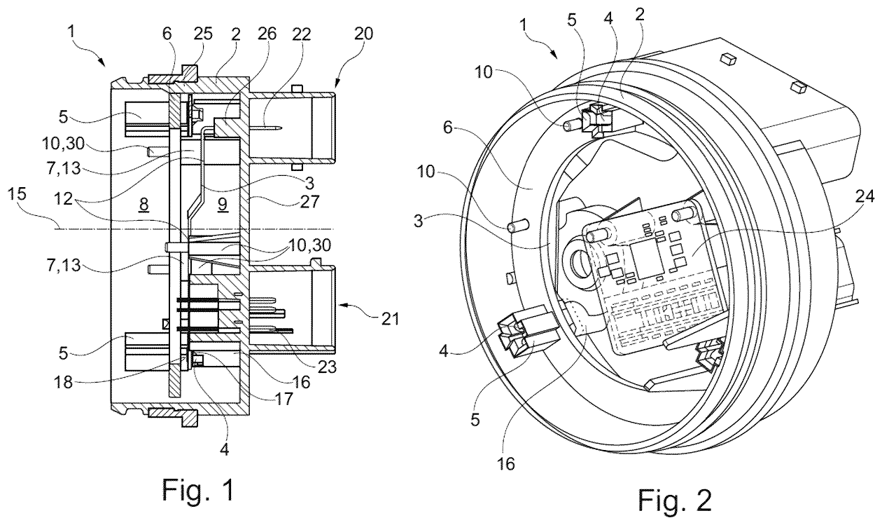

FIG. 1 shows a section through a connector module 1 for an actuator, not shown in this case. The housing 2 of the connector module 1 is shown with two terminal sockets 20, 21. In the terminal socket 20, terminals 22 of a lead frame 3 of the connector module are placed outwards so that a corresponding connector or terminal can make contact with them. In the second terminal socket 21, terminals 23 for a circuit board 24 provided within the connector module 1 are guided outwards. The lead frame 3 is used to securely contact an actuator-internal load, such as an electric motor with the terminals connected to the terminals 22, or a power electronics unit and/or control module connected to these terminals.

The housing 2 has a cylindrical portion 25 which radially encloses the lead frame 3 and the circuit board 24. The cylindrical portion 25 can define an axis 15 around which the cylindrical portion 25 extends in the circumferential direction. The axis 15 is arranged perpendicular to the plane of both the lead frame 3 and the circuit board 24.

Starting from the terminals 22, the lead frame 3 has a coaxial course relative to the axis 15 and is guided through a feedthrough 26 through an axial edge region 27 of the housing 2. Inside the housing 2, the lead frame 3 extends substantially in one plane, although steps may also be present if required. The lead frame 3 extends in the circumferential direction substantially parallel to the cylindrical portion 25 and coaxially with respect to the axis 15. The lead frame 3 has a substantially partially annular profile on the inner radius of the cylindrical portion 25.

The lead frame 3 rests in the axial direction on housing structures 30 of the housing 2, which are designed here as pins 10 with projections 11.

The projections 11 have a surface 12 which is designed in the manner of an end face of the projections 11 and from which the pins 10 extend further in the axial direction.

The surfaces 12 can be disposed at different axial levels with respect to the axial edge region 27 of the housing 2, following the corresponding axial course of the lead frame 3, which, as already mentioned, can have steps that lead to such different axial levels. The surfaces 12 are used for the axial positioning and support of the lead frame 3.

The projections 11 are disposed on the housing side between the lead frame 3 and the axial edge region 27. On the other side of the lead frame 3, the pins 10 extend further in the axial direction.

Furthermore, contact receptacles 16 extending in the axial direction are provided on the housing side. These contact receptacles 16 accommodate contacts 4. The contact receptacles 16, like the pins 10, have end faces in the form of surfaces 17, which are also used for the axial positioning and supporting of the lead frame 3.

By arranging the contact receptacles 16 and pins 10 in the circumferential direction and at predetermined radial distances, in conjunction with corresponding holes and contact points in the region of the lead frame 3, a poka-yoke structure can be formed which specifies the radial and circumferential position of the lead frame 3. For this purpose, the lead frame 3 has, on the one hand, holes that allow the pins 10 to pass through axially and, on the other hand, contact points that allow the contacts 4 to reach through with simultaneous, electrically conductive contact with the lead frame 3.

The lead frame 3 is held and supported axially by a support ring 6 in the connector module 1 on the axial side opposite the axial edge region 27. The support ring 6 follows the inner radius of the cylindrical portion 25 of the housing 2 substantially parallel to the lead frame 3.

The support ring 6 has integral structures for axially positioning and holding the lead frame 3, on the one hand, and at least supporting the contacting of the lead frame 3 with the actuator-internal load.

On a side 9 facing the lead frame 3, the integral structures are formed into a first part as fastening elements 7 in the form of spacer sleeves 13, which can extend axially to different extents according to the axial course of the lead frame 3. The spacer sleeves 13 have end sides with surfaces 14 which, when the connector module 1 is assembled, are opposite the surfaces 12 of the pins 10 and with said pins fix the axial position of the lead frame 3 and support the lead frame 3. The support ring 6 and its integral structures consist of an electrically insulating plastic.

The integral structures on the side 9 facing the lead frame 3 are formed into a second part as receptacles 18. Both the receptacles 18 and the spacer sleeves 13 are integral, are integrally bonded components of the support ring 6 and are made of an electrically insulating plastic. The receptacles 18 are hollow radially on the inside and allow the contacts 4 to pass through the support ring 6. They are disposed axially opposite the contact receptacles 16 and have corresponding end sides with surfaces 19. In this case also, the lead frame 3 is jointly positioned and supported axially by the surfaces 16 of the contact receptacles 16 and the surfaces 19 of the receptacles 18. At the same time, contacting of the lead frame 3 with the contacts 4 is made possible and the contacts 4 are simultaneously guided through to the other side 8 of the support ring 6. In particular, the contact receptacles 16 or receptacles 18 can also be part of the described poka-yoke structure.

As described, the receptacles 18 are hollow radially on the inside and are arranged at the locations of the lead frame 3 with contact points for contacting the contacts 4. The support ring 6 also has a passage at these locations for the contacts 4 to axially pass through. On the side 8 of the support ring 6 opposite the lead frame 3, the integral structures are at least partially designed as supports 5. These supports 5 are hollow on the inside and extend axially into the space of the side 8. At their axial ends, they can ensure contact of the contacts 4 with contact points/connectors (not shown here) of an actuator-internal load, such as an electric motor. For this purpose, the supports 5 themselves can have a conductive end region for contacting both the contacts 4 and the contact points of the load. In the case shown here, however, the supports 5 have an axial opening so that plug contacts can engage here. The contacts 4 are preferably designed as insulation-displacement contacts so that a secure connection is created by the contacts of the load and the contacts 4 engaging together.

FIG. 2 shows the connector module 1 in a 3D representation. The support ring 6 can be seen adjacent to the inner radius of the cylindrical portion 25. The pins 10 pass through it axially on the housing side and fix the lead frame 3, partially visible here, both axially between projections 11 and fastening elements 7. Furthermore, the supports 5 with the contacts 4 disposed therein can be seen. In this case also, as described above, axial and circumferential positioning of the lead frame 3 is supported, while at the same time secure contacting of the contacts 4 can be achieved.

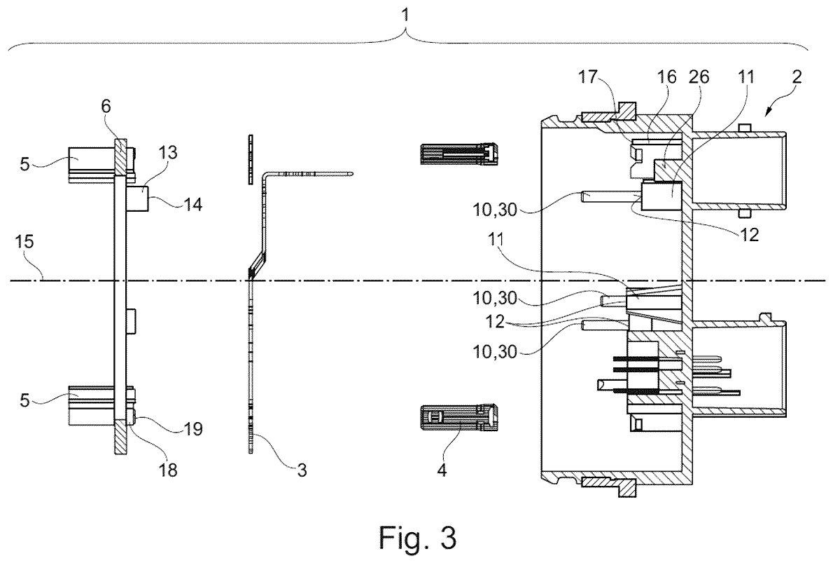

FIG. 3 shows an exploded view of the connector module 1, from which the method for assembling the connector module 1 can be seen.

The housing 2 has contact receptacles 16 on the inside, which are integrally formed from the plastic of the housing 2. They are used accommodate contacts 4, which are inserted axially into the contact receptacles 16, as shown here.

Furthermore, the housing here also integrally comprises pins 10 with projections 11.

After insertion of the contacts 4, they are connected to the lead frame 3. The lead frame 3 has contact points and holes that are not visible here but correspond to the contacts 4 and the pins 10.

The lead frame 3 has axially extending terminals 22. These are guided through a feedthrough 26, while the lead frame 3 is placed axially on the surfaces 14 and 17 of the projections 11 and contact receptacles 16. The holes of the lead frame 3 then accommodate the pins 10, while the contact points establish contact with the contacts 4.

In a final step, the support ring 6 is placed axially on the lead frame 3 and is slid over the pins 10 and the contacts 4. The positions of the contacts 4 and pins 10 form a poka-yoke structure, which corresponds to the integral structures of the support ring 6. When slid on, the pins 10 are pushed through spacer sleeves 13 on the side 9 of the support ring 6 facing the lead frame 3 and pass through both the spacer sleeves 13 and the support ring 6 axially. In this step, the contacts 4 pass through receptacles 18 on the side 9, the support ring 6 and supports 5 on the side 8 of the support ring 6 facing away from the lead frame 3. In particular, the contact between the contacts 4 and the supports 5 can ensure that the support ring 6 is securely seated. The lead frame 3 is securely held axially between the support ring 6 and the housing 2, while the contacts 4 ensure contact with respect to the load and the terminals 22 ensure contact with respect to the supply lines. The connector module 1 is a subassembly in a transportable and testable state. It can be easily assembled and requires a minimal number of individual parts.

### LIST OF REFERENCE SIGNS

1 Connector module
2 Housing
3 Lead frame
4 Contacts
5 Support
6 Support ring
7 Fastening element
8.9 Side
10 Pin
11 Projection
12, 14 Surface
13 Spacer sleeve
15 Axis
16 Contact receptacle
17 Surface
18 Receptacle
19 Surface
20 Terminal socket
21 Terminal socket
22 Terminals
23 Terminals
24 Printed circuit board
25 Cylindrical portion
26 Feed-through
27 Axial edge region
30 Housing structures

1. A connector module comprising:
a housing,
a lead frame,
contacts for contacting the lead frame with a load and supports for supporting the contacts, and
a support ring accommodated in the housing, and wherein the support ring integrally forms both the supports and fastening elements for fastening the lead frame to the housing.

2. The connector module according to claim 1, wherein the supports and fastening elements are arranged on opposite sides of the support ring.

3. The connector module according claim 1, wherein the fastening elements are female connectors for receiving male connectors on the housing.

4. The connector module according to claim 3, wherein the male connectors are integrally formed from the housing and the female connectors are integrally formed from the support ring.

5. The connector module according to , claim 3, wherein a male connector protrudes from a projection, the projection has a surface parallel to the lead frame, a female connector has a surface parallel to the lead frame, and the lead frame is fixed in its axial position with respect to an axis through the housing by the lead frame being in contact with the two surfaces.

6. The connector module according to claim 1, wherein the contacts are accommodated in contact receptacles of the housing with a surface, the support ring has receptacles facing the surface with a surface, and the contacts protruding through the surfaces and the lead frame are supported in the supports on a side of the support ring facing away from the lead frame.

7. An actuator comprising a connector module according to claim 1, wherein the load contacting the lead frame is an electric motor.

8. A method for assembling a connector module having a housing,
a lead frame,
contacts for contacting the lead frame with a load and supports for supporting the contacts, and
a support ring accommodated in the housing, wherein the support ring integrally forms both the supports and fastening elements for fastening the lead frame to the housing, wherein the fastening elements are female connectors for receiving male connectors on the housing, the method comprising:
accommodating the contacts in contact receptacles of the housing, then
positioning the lead frame by the contacts and male connector of the housing in the radial direction with respect to an axis,
arranging the support ring axially on the lead frame
wherein the contacts are accommodated in supports of the support ring, and the lead frame is fixed in the axial direction by a surface of the contact receptacles and a complementary surface of the female connectors of the support ring as well as by a surface of projections of the male connectors, and
the support ring is fastened to the housing so that positioning and fastening of the lead frame is carried out solely via the support ring and the contacts.

9. The method according to claim 8, wherein the supports and fastening elements are arranged on opposite sides of the support ring.

10. The method according to claim 9, wherein the male connectors are integrally formed from the housing and the female connectors are integrally formed from the support ring.

11. The method according to claim 9, wherein each male connector protrudes from a projection, the projection has a surface parallel to the lead frame, a female connector has a surface parallel to the lead frame, and the lead frame is fixed in its axial position with respect to an axis through the housing by the lead frame being in contact with the two surfaces.

12. The method according to claim 8, wherein the contacts are accommodated in contact receptacles of the housing with a surface, the support ring has receptacles facing the surface with a surface, and the contacts protruding through the surfaces and the lead frame are supported in the supports on a side of the support ring facing away from the lead frame.

13. The method according to claim 8, wherein the load contacting the lead frame is an electric motor.
